(19) United States
(12) Patent Application Publication
(10) Pub. No.: US 2021/0333356 A1
(43) Pub. Date: Oct. 28, 2021

(54) SPACE-TIME ADAPTIVE PROCESSING USING RANDOM MATRIX THEORY

(71) Applicant: US Gov't as represented by Secretary of Air Force, Wright-Patterson AFB, OH (US)

(72) Inventor: Benjamin Robinson, Kettering, OH (US)

(21) Appl. No.: 17/236,441

(22) Filed: Apr. 21, 2021

Related U.S. Application Data
(60) Provisional application No. 63/177,065, filed on Apr. 20, 2021.
(60) Provisional application No. 63/013,565, filed on Apr. 22, 2020.

(51) Int. Cl. G01S 7/292

(52) U.S. Cl. CPC G01S 7/292

(57) ABSTRACT

A radar system includes a beamformer that uses space-time adaptive processing using random matrix theory.

### CROSS-REFERENCE TO RELATED APPLICATIONS

This application claims the benefit of priority under 35 U.S.C. § 119(e) to U.S. Provisional Application Ser. No. 63/177,065 entitled “Space-time adaptive processing using random matrix theory”, filed 20 Apr. 2021, the contents of which are incorporated herein by reference in their entirety.

This application claims the benefit of priority under 35 U.S.C. § 119(e) to U.S. Provisional Application Ser. No. 63/013,565 entitled “Space-time Adaptive Processing”, filed 22 Apr. 2021, the contents of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### BACKGROUND

Beamforming in modern space-time adaptive processing (STAP) traditionally makes use of adaptive matched filters for detection of difficult targets. These filters depend crucially upon the estimation of the interference covariance matrix from target-free cells adjacent to a potentially target-containing cell [Gue14]. Data received from each cell is a p=JP-dimensional complex vector, where J is the number of antennas and P is the number of pulses in each coherent processing interval. The traditional choice of covariance estimate is the so-called sample covariance matrix (SCM), which is the average outer product of the data received from several target-free cells. While the behavior of the SCM in a matched filter is well-understood, for satisfactory false-alarm and detection rates computations with it are often prohibitive. An example of a radar with STAP includes U.S. Pat. No. 8,633,850 B2, the disclosure of which is hereby incorporated by reference in its entirety.

### DETAILED DESCRIPTION

The state-of-the-art detection algorithms in downward-facing airborne radar is the rank-constrained maximum likelihood-lb (RCML-lb) method, which is a member of the so-called “shrinkage class.” One may ask the question, within this class, what detector is the most powerful? Besides RCML-lb, a competing method is a random-matrix-theory based approach. Each of these has its shortcomings, though. The RMT method fails in some parameter ranges but is optimal elsewhere, and RCML-lb is decent everywhere but optimal nowhere. This invention is a new family of algorithms that poses a novel solution to the well-known and important question above, in particular improving on both of the above methods everywhere. The approach is to use both physical knowledge and RMT to speed the convergence of the RMT-based method. In addition, a sub-class of this family comes with performance predictions when noise/interference is additive and Gaussian.

Automotive radar in an urban environment is a particularly compelling use-case, because the noise environment is quickly changing and the invention enables assured detection (of obstacles, for example) in such environments. The same is true of drones in an urban environment.

Beamforming is central in processing of data from antenna arrays. The primary defense application is downward facing airborne radar detection. Commercial applications would be speech processing, or detection of vehicles/obstacles by an autonomous-vehicle-borne radar in an urban environment. The invention will outperform both the SCMLS methods and the Ledoit-Wolf methods by modifying the latter method to include physical knowledge of the radar system. This knowledge about the physics of the radar system is incorporated to thwart as much as possible the occasional failures of the Ledoit-Wolf method.

Space-Time Adaptive Processing Using Random Matrix Theory (RMT-STAP):

One problem addressed is to reduce or minimize the number of missed detections of an adaptive beamformer applied to colored spatio-temporal data received on an antenna array mounted on a moving platform, for a given false-alarm rate. In addition, existing techniques often come without a prediction of detection performance, and such a prediction is desired.

Traditional beamformer methods include: structure-constrained maximum like-lihood shrinkage (SCMLS) methods [1, 12, 4, 10, 15], Bayesian [3] methods, and diagonal-loading methods [6]. The problem of designing adaptive beam-formers to perform detection by suppressing the effects of noise, interference, and clutter is generally referred to as space-time adaptive processing (STAP). All of the above beamformers are designed to handle the case where inferences must be made from the often small available amounts of homogeneous target-free secondary data. While these techniques possess differing levels of success, the primary concern is to maximize detection performance—i.e., to maximize the detection probability for a given false-alarm rate. Bayesian techniques often suffer from prior assumptions that are too strong to be relevant or too weak to be useful. Diagonal loading can be done optimally in a sense, but that sense is dependent upon the ancillary notion of Frobenius distance [6]. Finally, SCMLS methods, though state-of-the-art, typically rely heavily on simplifying assumptions about noise structure, leading to sub-optimal behavior [11].

Certain random matrices (matrices whose entries are random variables), originally studied in physics [14] and in [9], have the unique property that their spectra converge to a deterministic set as the dimensions of the matrix go to infinity in a fixed ratio. The authors of [8, 7] exploited this fact in the context of mathematical finance to find optimal weights for stocks in a portfolio given a short time-series for each stock, but their results are equally applicable to maximizing detection performance in STAP [11]. However, their estimators be-comes suddenly ill-conditioned when the ratio of the dimensions of the matrix of target-free secondary data is near one, resulting again in sub-optimal behavior.

Discussion: Proposed Solution:

Let n be the number of secondary data and p be the dimensionality of the data and n≠p, and let \hat{R}_{sc} be the sample covariance of the secondary data. Limit beamformers only to adaptive matched filters and the covariance estimator in the adaptive matched filter to a rotation-equivariant shrinkage estimator of the type described in [8, 7, 11] (i.e., to “nonlinear shrinkage estimators”). In other words, assume the eigenvectors of this estimator are all eigenvectors of \hat{R}_{sc}. Assume ƒ(x) Is a probability density supported on the positive real numbers, and let \check{m}(λ)=π [symbol] _{ƒ}(λ)+iπƒ(λ), where [symbol] _{ƒ} is the Hilbert transform of ƒ:

$${f}_{} ( x ) = \frac{1}{π} PV {\int }_{- ∞}^{∞} \frac{f ( t )}{t - x} dt .$$

We assume further that \hat{R}₀ is of the form Udiag{δ(λᵢ)}ᵢ₌₁^{p}U′, where U=[u₁, u₂, . . . uₚ] is a matrix of eigenvectors of \hat{R}_{sc}, λᵢ are the corresponding eigenvalues, and

$$δ ( λ ) = \frac{λ}{{\vert 1 - \frac{p}{n} - \frac{p}{n} {m}^{} ( λ ) \vert}^{2}} , \\ or$$

$$δ ( λ ) = \{ \begin{matrix}\frac{1}{{π}^{2} λ ( {f ( λ )}^{2} + {f}_{} {( λ )}^{2} )} , & if λ > 0 \\ \frac{1}{π ( p / n - 1 ) {f}_{} ( 0 )} , & if λ = 0\end{matrix} .$$

(The first is appropriate for n>p and the second for n<p.) Particular dunces of ƒ can be found in [8, 7]. Assume, as in [4], the true underlying interference-and-noise covariance has the form R=R_{c}+σ² I, where rank R_{c}≤r for some nontrivial r and π²>0 and I is the identity matrix. The innovation proposed here is to improve the estimators in [8, 7] using prior knowledge or estimates of r and/or σ in such a way that it outperforms both [8, 7] and SCMLS methods. More precisely, we wish to threshold the eigenvalues of \hat{R}₀ from below by some function ƒ(Λ, \hat{r}, \hat{σ}²), where Λ is the spectrum of \hat{R}_{sc} and \hat{r} and \hat{σ}² are estimates for r and σ². Possible choices for \hat{r} include Brennan's rule [2], the work of [5], MDL-like estimates [13], and many other's. Possible choices for \hat{σ}² could come from the radar device manufacturer specifications, receive-only-mode measurements of ambient noise. Given \hat{r}, a possible choice of ƒ(Λ, \hat{r}, \hat{σ}²) could then be, max{\hat{σ}², \hat{σ}²}, where \hat{σ}² the average of the eigenvalues of the sample covariance matrix, excepting the \hat{r} largest ones, as in [4, 1]. Given \hat{σ}², another choice of ƒ(Λ, \hat{r}, \hat{σ}²) is just \hat{σ}², as in [11]. In general ƒ(Λ, \hat{r}, \hat{σ}²) could depend upon a mix of knowledge-based, max-likelihood, random-matrix theoretic, and physical considerations. We call the resulting architecture RMT-STAP.

Product Capabilities and Highlights:

In the large-dimensional limit, some estimators of the form of \hat{R}₀ are guaranteed to be optimal within the class above, as in [8, 7], except when p/n→1. But problems near n p are obviated for finite sample sizes if ƒ(Λ, \hat{r}, \hat{σ}²) is a relatively light underestimate of \hat{σ}². This leads to an imporved detector within the most popular class of radar detectors. Additionally, if the noise process is additive and Gaussian and the large-dimensional limit is in force, probabilies of detection and false-alarm can be expressed in closed form and are essentially deterministic. This gives the operator/agent a measure of reliability of the detector.

Product Challenges;

The biggest challenge is how to design a rank estimator r. This is a well-known unsolved (in face, somewhat ill-posed) problem in signal processing. As discussed there are many alternatives, but at the moment, none stands out as universally superior. In practice, however, performance is typically not very sensitive to changes in rank [4], and the simple Brennan's rule leads to near-optimal performance. An additional challenge is that theoretical performance predictions are only valid in the high-dimensional limit and for additive Gaussian noise/interference. This limit appears to be achieved in dimensions in the low hundreds, but no guarantees of fast convergence have yet been discovered. However, in analogy with the Central Limit Theorem, the “rule of 30” seems to apply: at least 30 dimensions and noise/interference samples is enough to realize convergence in practice for most data sets. We note that this problem is not unique to our method: all of the methods described in the Background section can only be shown to perform in a satisfactory way in some asymptotic limit.

Conclusion: Utilizing advances in random matrix theory, RMT-STAP is a technique for detecting difficult targets in highly nonstationary noise/interference. This invention advances the detection field by solving two problems: (1) it is the optimal technique within the most popular class of adaptive beamformers, and (2) it has predictable detection performance when noise is additive and Gaussian.

References cited above are hereby incorporated by reference in their entirety.
[1] Theodore Wilbur Anderson et al. Asymptotic theory for principal compo-nent analysis. Annals of Mathematical Statistics, 34(1):122-148, 1963.
[2] L. E. Brennan and F. M. Staudaher. Subclutter visibility demonstration. Technical report, Tech. Rep., RL-TR-92-21, Adaptive Sensors Incorporated, 1992.
[3] L. R. Haff. Empirical Bayes estimation of the multivariate normal covariance matrix. The Annals of Statistics, pages 586-597, 1980.
[4] Bosung Kang, Vishal Monga, and Muralidhar Rangaswamy. Rank-constrained maximum likelihood estimation of structured covariance matri-ces. IEEE Transactions on Aerospace and Electronic Systems, 50(1):501-515, 2014.
[5] Bosung Kang, Vishal Monga, Muralidhar Rangaswamy, and Yuri I Abramovich. Automatic rank estimation for practical STAP covariance estimation via an expected likelihood approach. In 2015 IEEE Radar Conference (RadarCon), pages 1388-1393. IEEE, 2015.
[6] Olivier Ledoit and Michael Wolf A well-conditioned estimator for large-dimensional covariance matrices. Journal of Multivariate Analysis, 88(2):365-411, 2004.
[7] Olivier Ledoit and Michael Wolf Analytical nonlinear shrinkage estimation of large-dimensional covariance matrices, 2017.
[8] Olivier Ledoit and Michael Wolf. Working paper 264: Direct nonlinear shrinkage estimation of large-dimensional covariance matrices, 2017.
[9] Vladimir A. Marcenko and Leonid Andreevich Pastur. Distribution of eigenvalues for some sets of random matrices. Mathematics of the USSR-Sbornik, 1(4):457, 1967.
[10] Irving S. Reed, John D. Mallett, and Lawrence E. Brennan. Rapid convergence rate in adaptive arrays. IEEE Transactions on Aerospace and Electronic Systems, (6):853-863, 1974.
[11] Benjamin D. Robinson. Optimal rotation-equivariant covariance estimation for detection of high-dimensional signals. Accepted by IEEE Radar Conference (RadarConf), 2019.
[12] Michael Steiner and Karl Gerlach. Fast converging adaptive processor for a structured covariance matrix. IEEE Transactions on Aerospace and Elec-tronic Systems, 36(4):1115-1126, 2000.
[13] Mati Wax and Thomas Kailath. Detection of signals by information theoretic criteria. IEEE Transactions on Acoustics, Speech, and Signal Processing, 33(2):387-392, 1985.
[14] Eugene P. Wigner. On the statistical distribution of the widths and spac-ings of nuclear resonance levels. In Mathematical Proceedings of the Cam-bridge Philosophical Society, volume 47, pages 790-798. Cambridge Univer-sity Press, 1951.
[15] Joong-Ho Won, Johan Lim, Seung-Jean Kim, and Bala Rajaratnam. Condition-number-regularized covariance estimation. Journal of the Royal Statistical Society: Series B (Statistical Methodology), 75(3):427-450, 2013.

Low-Complexity Space-Time Adaptive Processing: Current Design:

The matched filter statistic most commonly used is Robey's Generalized-Likelihood-Ratio-Test (GLRT) statistic [RFKN92], which makes use of the SCM. This algorithm replaces the “Covariance estimate” block in the block diagram of Melvin [Mel14, FIG. 12.29], which outlines the full space-time adaptive processing chain.

We propose replacing the “Covariance estimate” block by the Ledoit-Wolf co-variance estimator, described in [LW17]. In either case, the computation time is dominated by the singular-value decomposition of the matrix of however many target-free samples are used. The goal, then, is to reduce the number of target-free samples needed for the GLRT while preserving the same false-alarm and detection rate.

What Makes the Invention Novel/What is the Value:

In the context of mathematical finance, Ledoit and Wolf [LW17] have devised a covariance estimator which, asymptotically in the limit of high dimensions and many noise-only samples, gives the weights maximize the risk-reward ratio of a selected portfolio. Although their application domain is apparently unrelated to radar, the objective function they consider (expected return divided by standard deviation) appears in radar as Reed-Mallett-Brennan (RMB) loss in an essentially identical form, with steering vectors replacing a portfolio weight vectors. Further, under traditional models, lower RMB loss always means higher detection probability for every given false-alarm rate [RMB74]. Thus, the Ledoit-Wolf covariance matrix estimator, which provides the weights of an optimal portfolio, also provides the weights of an optimal beamformer.

The above observation is useful in the pursuit of computational efficiency in beamforming: If a covariance estimator attains lower RMB loss for each number of target-free samples, then for a given desired RMB loss, fewer target-free samples are required.

Given data from N target-free cells, we thus compare the two options:

(Common Design) Use all N data to compute the sample covariance matrix and form the Robey GLRT. This incurs a RMB loss of roughly 1 p/N [RMB74].

(Proposed Design) Use a subset of data of size n=Nr/p to compute the Ledoit-Wolf covariance matrix estimator and form a plug-in Robey GLRT, as described in [Rob19, RMH20]. This incurs an RMB loss of roughly 1 r/n, where r is the number of clutter signals. The novelty of our invention is to use the Ledoit-Wolf estimator in place of the SCM, and use only a reduced data set. What is the value? If we set n equal to Nr/p, then the amount of computation time needed is dominated by computing the singular value decomposition of a p-by-n matrix, which is O(n2p+p2n) [GK65]. Since r is typically much smaller than p (cite Brennan's rule), this is a significant speedup over the O(N 2p+p2N) time needed to compute the singular value decomposition of the sample covariance matrix. Thus, we propose method number 1.

Recommendations: For best results, the received data should be multivariate-Gaussian distributed. p and n should be large, and p/n should not be close to 1.

References cited above are hereby incorporated by reference in their entirety:
[GK65] Gene Golub and William Kahan. Calculating the singular values and pseudo-inverse of a matrix. Journal of the Society for Industrial and Applied Mathematics, Series B: Numerical Analysis, 2(2):205-224, 1965.
[Gue14] Joseph R. Guerci. Space-time adaptive processing for radar. Artech House, 2014.
[LW17] Olivier Ledoit and Michael Wolf. Working paper 264: Direct non-linear shrinkage estimation of large-dimensional covariance matrices, 2017.
[Me114] William L. Melvin. Space-time adaptive processing for radar. In Academic Press Library in Signal Processing, volume 2, pages 595-665. Elsevier, 2014.
[RFKN92] Frank C. Robey, Daniel R. Fuhrmann, Edward J. Kelly, and Ramon Nitzberg. A CFAR adaptive matched filter detector. IEEE Transactions on Aerospace and Electronic Systems, 28(1):208-216, 1992.
[RMB74] Irving S. Reed, John D. Mallett, and Lawrence E. Brennan. Rapid convergence rate in adaptive arrays. IEEE Transactions on Aerospace and Electronic Systems, (6):853-863, 1974.
[RMH20] Benjamin D. Robinson, Robert Malinas, and Alfred O. Hero. Space-time adaptive detection at low sample support. arXiv preprint arXiv:2010.03388, 2020.
[Rob19] Benjamin D. Robinson. Optimal rotation-equivariant covariance estimation for detection of high-dimensional signals. In 2019 IEEE Radar Conference (RadarConf), pages 1-6. IEEE, 2019.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. a radar system comprising a beamformer that uses space-time adaptive processing using random matrix theory.
